(19) United States
(12) Patent Application Publication
(10) Pub. No.: US 2026/0329681 A1
(43) Pub. Date: Oct. 22, 2026

(54) DEPENDENCY-AWARE DETECTION OF SERVICE AVAILABILITY DRIFT

(71) Applicant: Hewlett Packard Enterprise Development LP, Spring, TX (US)

(72) Inventors: Thavamani Raja Sakthivel, Bangalore Karnataka (IN); Harish Nair Rajagopal, Bangalore Karnataka (IN); Vinnarasu Ganesan, Bangalore Karnataka (IN)

(21) Appl. No.: 19/260,972

(22) Filed: Jul. 7, 2025

(30) Foreign Application Priority Data
Apr. 17, 2025 (IN) 202541037257

(51) Int. Cl. G06F 11/00; G06F 11/07

(52) U.S. Cl. CPC G06F 11/008; G06F 11/079; G06F 11/0793; G06F 2201/805

(57) ABSTRACT

The present disclosure relates to detecting and managing service availability drift in cloud environments. Dependency information for a service environment is collected, the service environment comprising a core service and dependent services. An estimated availability for the core service is calculated based on service characteristics of the dependent services. Operational metrics for the core service and dependent services are collected. An actual availability for the core service is calculated based on the operational metrics. A drift between the estimated availability and actual availability for the core service is detected. A root cause of the drift is determined by analyzing the dependency information. The service environment is then updated based on the root cause of the drift.

### BACKGROUND

Modern software systems are increasingly designed using a microservice architecture. This approach involves breaking down large applications into smaller, independent services that can be developed, deployed, and scaled separately. Each microservice typically focuses on a specific business capability and communicates with other services through well-defined interfaces.

In a microservice-based system, the overall functionality depends on the interaction between multiple services. These services may be distributed across different servers or even different geographical locations. The communication between microservices often occurs over network protocols, introducing potential points of failure or latency.

The availability of a microservice-based system is influenced by various factors. These can include the reliability of individual services, network connectivity, hardware performance, and the ability to handle concurrent requests. Additionally, the system’s overall availability may be affected by external factors such as environmental conditions, power stability, or even human errors during maintenance or configuration changes.

Monitoring and managing the availability of microservice-based systems presents unique challenges. As the number of services increases, so does the complexity of tracking their performance and interactions. System administrators and developers need to consider not only the status of individual services but also how they work together to deliver the intended functionality.

Ensuring high availability in microservice architectures often involves implementing strategies such as redundancy, load balancing, and fault tolerance. These approaches aim to minimize downtime and maintain system performance even when individual components experience issues. However, implementing and maintaining these strategies can be complex, especially as systems grow and evolve over time.

### BRIEF DESCRIPTION OF THE DRAWINGS

For a more complete understanding of this disclosure, and advantages thereof, reference is now made to the following descriptions taken in conjunction with the accompanying drawings.

FIG. 1 illustrates a block diagram of a computing system, according to some implementations.

FIG. 2 illustrates a block diagram of a service environment, according to some implementations.

FIG. 3 illustrates a block diagram of a service environment, according to some implementations.

FIG. 4 illustrates a block diagram of the software architecture of a cloud platform, according to some implementations.

FIG. 5 illustrates a flowchart of a method for detecting and responding to service drift, according to some implementations.

FIG. 6 illustrates a flowchart of a method for monitoring and managing service availability, according to some implementations.

Corresponding numerals and symbols in the different figures generally refer to corresponding parts unless otherwise indicated.

### DETAILED DESCRIPTION

The following disclosure provides many different examples for implementing different features. Specific examples of components and arrangements are described below to simplify the present disclosure. These are, of course, merely examples and are not intended to be limiting.

In modern distributed systems and microservice architectures, estimating and ensuring service availability and reliability is an important challenge. Current approaches often rely on simplistic estimates of service availability without considering the complex dependencies between services and components. This can lead to inaccurate predictions of service availability and unexpected service disruptions. Additionally, as services evolve and dependencies change over time, maintaining accurate availability estimates becomes increasingly difficult. In these environments, a core service typically provides a given functionality, while relying on multiple dependent services. The overall availability of the core service’s functionality thus depends on both the availability of the core service itself as well as the availability of its dependencies.

This disclosure describes a dependency-aware system for detecting and managing service availability drift in service environments. The system utilizes a dedicated service reliability server to oversee and analyze the service environment. This reliability server collects service dependency information for the service environment, including characteristics of a core service and its dependent services in the system architecture. The dependency information may include reliability parameters, availability parameters, and/or similar metrics. Using this information, the reliability server calculates an estimated availability for the core service based on the service characteristics of the dependent services and their relationships to the core service.

To monitor actual service performance, the reliability server collects operational metrics for both the core service and its dependent services. These metrics are used to calculate an actual availability for the core service. By comparing the estimated availability with the actual availability, the reliability server can detect any drift between the estimated and actual values. This drift detection may provide important insights into the health and performance of the service environment.

Upon detecting a drift, the reliability server may analyze the collected dependency information and metrics to determine the root cause of the drift. This analysis may involve examining which dependent services or components may be contributing to an availability discrepancy. The root cause analysis may consider various factors, such as changes in service characteristics, unexpected performance degradation, or shifts in usage patterns. The reliability server may utilize time-series data and apply numerical methods to analyze trends and patterns over time, helping to pinpoint the specific factors or events that led to a drift in service availability.

Based on the identified root cause, the service environment may be updated. Updating may involve modifying the service environment to reduce the drift and increase service availability. These updates may include increasing computing resource allocation to impacted services, adjusting redundancy levels of impacted services, and/or modifying other parameters to address the root cause of the drift. The reliability server may automatically implement these updates or provide recommendations for manual implementation to reduce the availability drift.

The dependency-aware drift detection and management system offers several advantages over other approaches. By considering the relationships between services and their dependencies in the system architecture, the system provides more accurate availability estimates and predictions. This enhanced accuracy allows for proactive identification and resolution of potential issues before they escalate into unexpected service disruptions. Furthermore, the system’s ability to adapt to changing service environments and automatically implement updates helps maintain consistent system reliability and policy compliance over time. These capabilities allow organizations to better manage their service architectures and prioritize availability for their users.

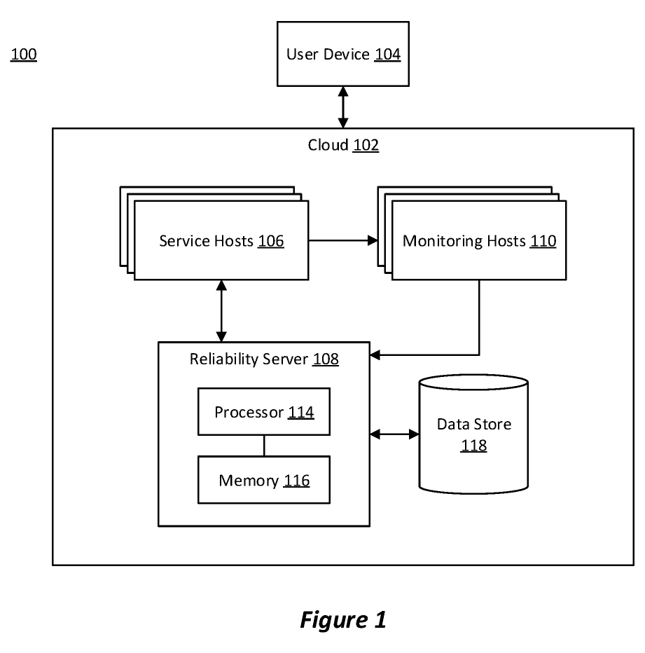

FIG. 1 illustrates a block diagram of a computing system 100, according to some implementations. The computing system 100 includes a cloud platform 102 that communicates with a user device 104. The cloud platform 102 includes service hosts 106 that interact with a reliability server 108, and also includes monitoring hosts 110 that interact with the service hosts 106 and the reliability server 108.

The cloud platform 102 may be implemented as a public, private, or hybrid cloud environment. Public cloud environments are operated by third-party providers and make resources available to multiple customers over the internet. Private cloud environments are dedicated to a single organization and may be hosted on-premises or by a third-party provider. Hybrid cloud environments combine elements of both public and private clouds, allowing data and applications to be shared between public and private systems. In some cases, the cloud platform 102 may include various types of networking infrastructure to facilitate communication between components, such as routers, switches, load balancers, firewalls, and the like. The cloud platform 102 may provide a range of functionality to the user device 104, including infrastructure functionality (e.g., compute, storage, and networking resources), common functionality (e.g., identity and access management, monitoring, and logging), and platform functionality (e.g., databases, application development tools, specialized business applications, and machine learning capabilities). This functionality is provided via microservices, which are designed to be scalable, flexible, and easily accessible, allowing users to quickly deploy and manage applications without the need to maintain underlying infrastructure.

The user device 104 may be operated by an end-user or an administrator. When operated by an end-user, the user device 104 may run an end-user client, such as an application, that accesses functionality provided by the cloud platform 102. When operated by an administrator, the user device 104 may run a management client, such as an administrative dashboard or monitoring interface, that enables users to configure, monitor, and manage resources within the cloud platform 102. The user device 104 may be any type of computing device, such as a desktop computer, laptop, smartphone, tablet, Internet of Things (IoT) device, or the like. These devices can connect to the cloud platform 102 through various network protocols, such as HTTP, HTTPS, WebSocket, proprietary APIs, or the like.

The service hosts 106 work together to provide functionality to the user device 104. These service hosts 106 may run microservices which work together to provide specific functionality of the cloud platform 102. The microservices running on the service hosts 106 may provide various features, such as user authentication, data processing, storage management, application-specific logic, or the like. The microservices may communicate with each other through defined APIs, typically using lightweight protocols such as HTTP or message queues. This modular approach allows for greater flexibility and resilience in the overall architecture of the computing system 100, and allows for easier updates to the services.

The service hosts 106 may implement the services using various technologies, including physical servers, virtual machines, containers, Kubernetes clusters, or the like. Physical servers refer to dedicated hardware machines that run the microservices directly on the bare metal. Virtual machines are software-based emulations of computer systems that can run multiple isolated operating system instances on a single physical machine. Containers are lightweight, portable environments that package applications and their dependencies, allowing for consistent deployment across different computing environments. Kubernetes clusters are groups of nodes (e.g., physical or virtual machines) that work together to run containerized applications, providing automated deployment, scaling, and management capabilities. For example, the microservices may be deployed as a set of pods within a Kubernetes cluster, where the cluster’s orchestrator may be used to scale the number of pod replicas up and down, or may be used to change the allocation of resources (e.g., CPUs, memory, etc.) to the pods.

A reliability server 108 monitors the reliability of the services running on the service hosts 106. The reliability server 108 may provide insights to system administrators regarding service performance and availability. Using information about the services, the reliability server 108 estimates what the availability of services should be. The reliability server 108 also calculates the actual availability of services using data collected from the services themselves. By comparing the estimated and actual availability of a service, the reliability server 108 can identify any drift in service performance. Based on detected drift, the reliability server 108 may initiate updates to the service environment (e.g., the service hosts 106) in order to address the detected drift.

As subsequently described, the reliability server 108 may utilize dependency information for the services, which includes details about how different services rely on each other to function, when estimating availability of the services running on the service hosts 106. By considering underlying dependencies, the reliability server 108 can provide a more accurate and comprehensive estimate of service availability, taking into account the complex relationships between core services and their dependent components during estimation.

The monitoring hosts 110 provide data about service operation from the service hosts 106 to the reliability server 108. In some implementations, the monitoring hosts 110 are dedicated components within the cloud platform 102 that collect and aggregate operational metrics from the service hosts 106. The operational metrics may include various performance indicators for the services, such as response times, error rates, resource utilization, transaction volumes, and the like. This data may be continuously gathered by the monitoring hosts 110, enabling real-time visibility into the health and performance of the microservices running on the service hosts 106. The data may be transmitted to the reliability server 108, which uses it to calculate the actual availability of services and detect any deviations from expected performance levels. Like the service hosts 106, the monitoring hosts 110 may be implemented using various technologies, including physical servers, virtual machines, containers, Kubernetes clusters, or the like. For example, the monitoring hosts themselves may be services hosted on Kubernetes (e.g., Prometheus) which collect metrics from Kubernetes pods and store time series data for analysis and visualization.

The reliability server 108 may include suitable components for performing any desired functionality. One or more modules within the reliability server 108 may be partially or wholly embodied as software and/or hardware for performing any functionality described herein. For example, the reliability server 108 may include a processor 114 and a memory 116. The processor 114 may be a microprocessor, an application-specific integrated circuit, a microcontroller, or the like. The memory 116 may be a non-transitory computer-readable medium that stores instructions for execution by the processor 114. The instructions, when executed by the processor 114, may cause the processor 114 to perform any functionality described herein.

The cloud platform 102 may also include a data store 118. The data store 118 may provide storage capacity for maintaining data related to service reliability and performance. The data store 118 may store information used to estimate service availability, such as service dependency relationships, reliability parameters, availability parameters, design limits of services, and the like. It may also store information used to calculate actual service availability, such as operational metrics, performance indicators, error rates, time-series data, and the like collected from the services. In some implementations, the data store 118 stores the service performance data from the monitoring hosts 110 and dependency information for services running on the service hosts 106. The data store 118 may be implemented using various storage technologies, such as relational databases, NoSQL data stores, distributed file systems, object storage, block storage, or the like.

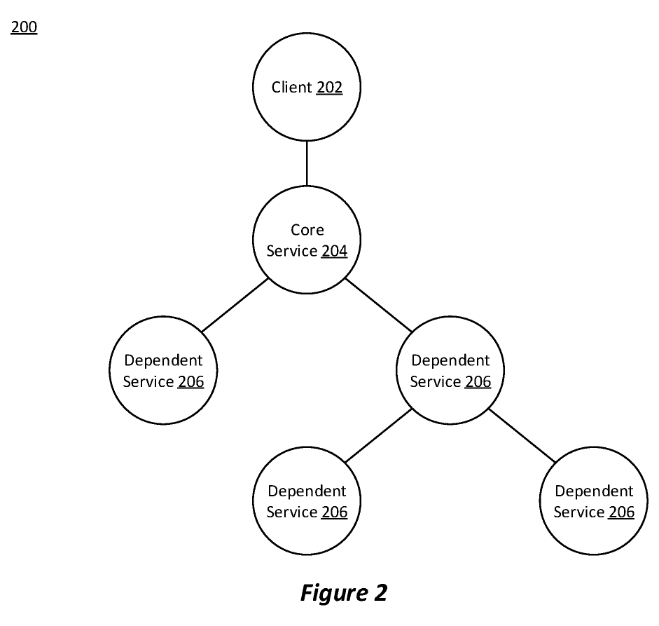

FIG. 2 illustrates a block diagram of a service environment 200, according to some implementations. The service environment 200 includes a client 202, a core service 204, and multiple dependent services 206. These may be software components which run on the hardware components of the computing system 100 described for FIG. 1.

A client 202 may be any application that interacts with the service environment 200. In some cases, the client 202 may be an end-user application running on the user device 104. In other cases, the client 202 may be an administrator application used to manage the service environment 200. The client 202 interacts with the core service 204 to access specific functionality provided by the service environment 200.

The core service 204 serves as the main entry point for the client 202, providing the primary interface through which the client 202 interacts with the service environment 200. While the core service 204 may implement some functionality directly, in many cases the core service 204 relies on multiple dependent services 206 to fulfill the client’s requests. For example, a media streaming core service might rely on content delivery, user subscription verification, recommendation engine, and digital rights management services to provide video streaming functionality to clients. This dependency structure creates a hierarchical relationship between the core service 204 and the dependent services 206.

The dependent services 206 support the operations of the core service 204. Each dependent service 206 may provide a specific function or set of functions that the core service 204 utilizes to complete its tasks. In some implementations, the dependent services 206 may form multiple layers, with some dependent services 206 relying on other dependent services 206 to perform their functions. This multi-layered structure creates a complex web of dependencies within the service environment 200.

The relationships between the core service 204 and the dependent services 206 significantly influence the overall functionality and availability of the service environment 200. For example, if an important dependent service 206 becomes unavailable, the core service 204 may be unable to provide its full range of functionality to the client 202. In some cases, the failure of a single dependent service 206 could render the core service 204 non-functional. Additionally, when dependent services 206 are nested in hierarchical layers, a failure in a lower-level dependent service 206 can propagate and impact a core service 204 which is far down the dependency chain, potentially causing cascading failures throughout the service environment 200. The degree of relationship between the services is also an important consideration - for a dependent service 206 that many other services depend on, even a small interruption in availability can contribute to large-scare unavailability of the service environment 200. Highly-connected dependent service 206 represent single points of failure that can amplify minor disruptions into significant system-wide outages, making their reliability particularly important to consider in assessing overall reliability of the service environment 200.

To accurately assess and manage the availability of the service environment 200, the reliability server 108 may collect and analyze dependency information for the service environment 200. The reliability server 108 uses the dependency information when estimating service availability and detecting potential issues within the service environment 200. This dependency information describes the relationships between the core service 204 and the dependent services 206, as well as the relationships among the dependent services 206 themselves. By understanding these dependencies, the reliability server 108 can more accurately estimate the availability of the core service 204 and the service environment 200.

The dependency information may include various characteristics and parameters related to the core service 204 and its dependent services 206. This information may include reliability parameters such as mean time between failures, availability parameters like redundancy levels, and design limits of the services 204 and 206. The dependency information may also include details about the relationships between the core service 204 and the dependent services 206, indicating which dependent services 206 depend on other dependent services 206 and the nature of those dependencies. The reliability server 108 may collect this information from various sources, either automatically or manually (e.g., from an administrator). By analyzing this information, the reliability server 108 can create a detailed map of the service environment 200, allowing for more accurate estimation of service availability and improved detection of potential issues that may arise due to the interactions between the core service 204 and the dependent services 206.

While not separately illustrated in FIG. 2, the service environment 200 may also depend on underlying platform and infrastructure components. These components, which may include elements such as the cloud platform 102, service hosts 106, and data store 118 of FIG. 1, form additional layers of dependency that may impact the availability of the core service 204.These underlying dependencies may also be part of the dependency information considered by the reliability server 108.

By analyzing the complex network of dependencies within the service environment 200, including both the direct relationships between the core service 204 and dependent services 206, as well as the underlying platform and infrastructure dependencies, the reliability server 108 can develop a more comprehensive and accurate estimation of service availability. This detailed understanding of the service environment 200 enables more effective management of service reliability and availability.

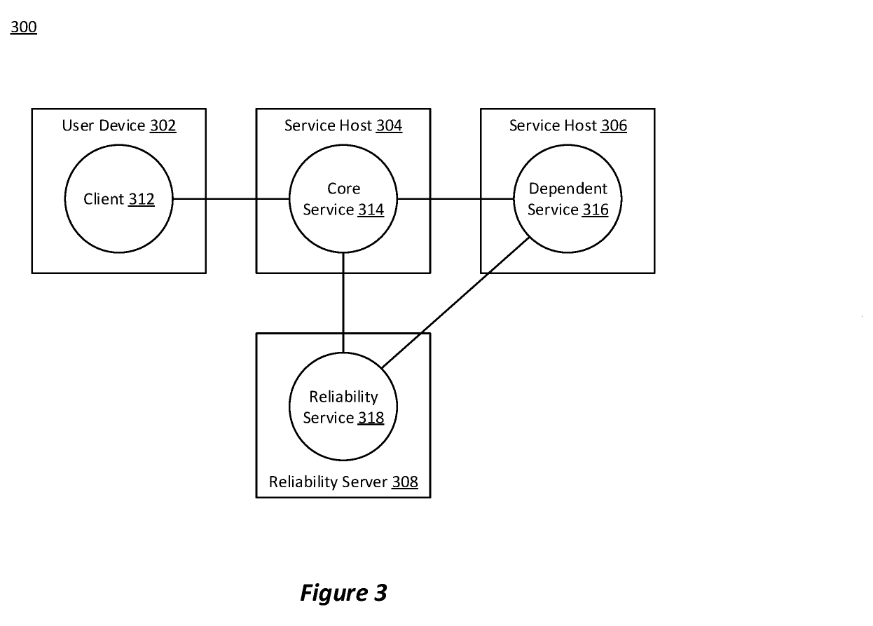

FIG. 3 illustrates a block diagram of a service environment 300, according to some implementations. The service environment 300 is implemented in a computing system that includes a user device 302, service hosts 304 and 306, and a reliability server 308. These components may be examples of the hardware components described for FIG. 1.

The user device 302 runs a client 312 that interacts with the service environment. In some cases, the client 312 may be an application running on the user device 302 that accesses functionality provided by the services in the service environment 300.

The service host 304 runs a core service 314, while the service host 306 runs a dependent service 316. These services may be examples of the software services described in FIG. 2. In this example implementation of a service environment, each service 314 and 316 runs on its own dedicated host. This allows for independent scaling of each service. For instance, the service host 304 running the core service 314 may be scaled up or down independently of the service host 306 running the dependent service 316. Addition configurations are contemplated. For example, a Kubernetes pod may include multiple services, and scaling up that pod’s number of instances may increase the availability of all services running within the pod. In such configurations, certain services may share resources and be deployed together as a unit. The choice between dedicated hosts and multi-service pods depends on specific requirements for isolation, resource utilization, and scaling strategies within the service environment.

The reliability server 308 runs a reliability service 318 that monitors and manages service reliability within the service environment 300. The reliability service 318 may continuously collect and analyze data from the core service 314 and the dependent service 316 to assess their performance and availability. The reliability service 318 also collects and stores dependency information for the services 314 and 316 in the service environment 300. This dependency information may describe the relationships between the core service 314 and the dependent service 316, as well as any other services or components in the system, and may be used in subsequent drift detection. Using the dependency information and collected data, the reliability service 318 calculates a drift between estimated and actual availability of the services 314 and 316, and may update the service environment 300 based on the presence and/or magnitude of that drift.

The reliability service 318 may implement a process for identifying and analyzing availability drift of the core service 314. This process may involve several steps, including collecting dependency information for the service environment 300, calculating estimated availability of the services 314 and 316, collecting operational metrics, determining actual availability of the services based on the operational metrics, and comparing these availability values to detect drift.

To calculate estimated availability of the core service 314, the reliability service 318 may utilize the dependency information collected for the core service 314 and the dependent service 316. This information may include service characteristics such as reliability parameters, availability parameters, design limits, and the like. The reliability service 318 may consider factors such as the mean time between failures and redundancy levels of each service. Using this data, the reliability service 318 may implement an algorithm (subsequently described) that accounts for the hierarchical relationship between the core service 314 and the dependent service 316. The algorithm may calculate how the availability of the dependent service 316 impacts the overall estimated availability of the core service 314. This process may involve combining individual service availabilities using methods such as multiplicative approaches or more complex statistical models.

To calculate actual availability of the core service 314, the reliability service 318 may collect operational metrics from both the core service 314 and the dependent service 316. These metrics may include response times, error rates, resource utilization, and transaction volumes. The reliability service 318 may process this data to derive key performance indicators such as uptime, downtime, and failure rates. Using these operational metrics, the reliability service 318 may calculate the actual availability of the core service 314 as a percentage, potentially using formulas that consider the mean time between failures and mean time to repair for the core service 314.

To detect availability drift of the core service 314, the reliability service 318 may compare the calculated estimated availability with the actual availability for the core service 314. This comparison may involve analyzing time-series data to identify various types of drift patterns. The reliability service 318 may detect sudden drift, characterized by abrupt changes in actual availability compared to the estimate. It may also identify gradual drift, where actual availability slowly diverges from the estimated value over time. Additionally, the reliability service 318 may recognize incremental drift, marked by step-wise changes in availability, or recurring drift patterns that show cyclical fluctuations.

Upon detecting availability drift of the core service 314, the reliability service 318 may perform root cause analysis to determine the factors contributing to the discrepancy between its estimated and actual availability. This analysis may involve examining the collected dependency information and operational metrics to identify which aspects of the core service 314 or dependent service 316 may be causing the drift. The reliability service 318 may use various statistical and mathematical techniques, such as trend analysis or time-series decomposition, to isolate different components of the drift and facilitate accurate root cause identification. The root cause of the drift may be determined based on the type of drift identified by analyzing time-series data for the estimated availability and time-series data for the actual availability.

The reliability service 318 may also examine the detected drift against a policy of the service environment 300 to predict whether the policy will be violated. This examination may involve analyzing the magnitude and trajectory of the drift to determine if it will exceed policy thresholds within a certain time frame. For example, if a system policy calls for 99.9% availability of a service, the reliability service 318 may predict whether the current drift pattern will cause the actual availability to fall below this threshold. If the reliability service 318 predicts that a policy violation will occur, it may calculate a deadline for updating the service environment 300 based on the dependency information and the rate of drift. The reliability service 318 may then arrange for the update to occur before that deadline, thereby reducing the risk of a policy violation occurring.

Based on the results of the drift detection and root cause analysis, the reliability service 318 may initiate updates to the service environment 300. These updates may include adjusting resource allocations, modifying service configurations, or the like for the core service 314 and/or the dependent service 316. In some implementations, these updates may be performed automatically in response to predicting that a policy will be violated, without requiring administrator intervention. The goal of these updates may be to align the actual availability more closely with the estimated availability and improve overall service reliability within the service environment 300, improving compliance with service policies. The specific type of update that is performed may be based on the root cause of the drift. For example, if the dependent service 316 is impacted in a way that affects the core service 314, the reliability service 318 may increase a computing resource allocation to the impacted service or increase a redundancy level of the impacted service.

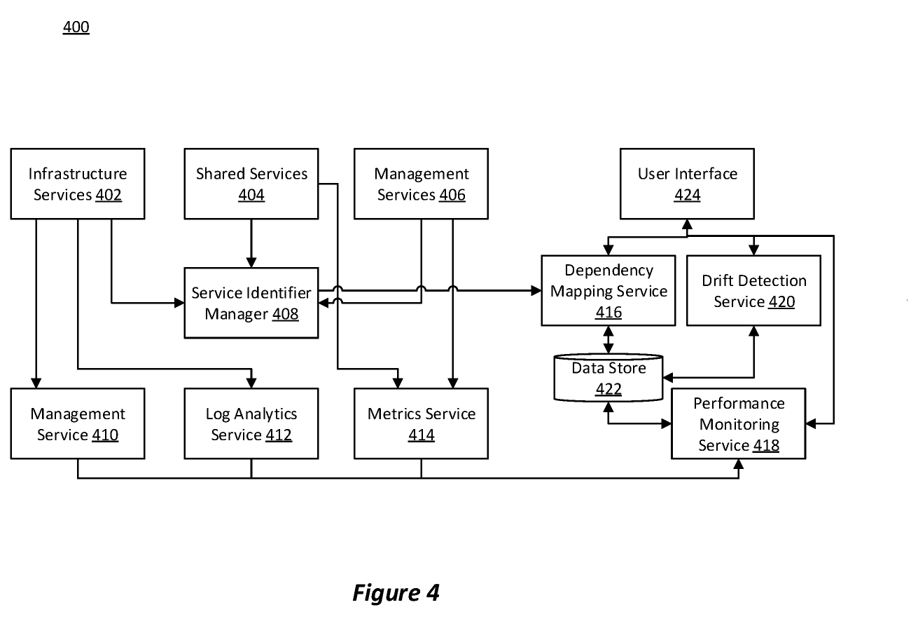

FIG. 4 illustrates a block diagram of the software architecture of a cloud platform 400, according to some implementations. The architecture is an example of various software components that may be used to implement, e.g., the service environment 300 of FIG. 3. It includes the main services providing cloud functionality (e.g., infrastructure services 402, shared services 404, and management services 406), monitoring services which collect service dependency and operational data (e.g., a service identifier manager 408, a management service 410, a log analytics service 412, and a metrics service 414), and reliability services which analyze availability and drift (e.g., a dependency mapping service 416, a performance monitoring service 418, and a drift detection service 420), a data store 422, and a user interface 424. This architecture provides a framework for monitoring and analyzing the availability of the main services. Thus, the cloud platform 400 may detect availability drift of those services and facilitate proactive management of service reliability.

The infrastructure services 402 may provide the foundational components of the cloud platform 400. These services may include compute, storage, and networking resources that form the basis of the cloud environment. The infrastructure services 402 may include Private Cloud Enterprise (PCE) services, which form the core infrastructure offerings that users can provision and manage within the cloud platform 400 Examples of PCE services include virtual machine as a service, bare metal as a service, and container as a service capabilities.

The shared services 404 may offer common functionality used across multiple applications or services within the cloud platform 400. These may include identity and access management, monitoring, and logging services that can be utilized by other services within the cloud platform 400. For example, the shared services 404 may provide centralized authentication mechanisms, user management capabilities, and resource access controls that ensure consistent security policies across the cloud platform 400. These services are designed to be consumed by multiple components including the infrastructure services 402 and other platform offerings, reducing the need for each service to implement its own version of common functions.

The management services 406 may provide tools for administering and controlling the cloud platform 400. These services may include features for resource allocation, user management, and overall system configuration. For example, resource allocation tools may allow administrators to dynamically assign compute, storage, and network resources to different services or applications based on demand and priority. User management features may encompass capabilities for creating and managing user accounts, setting access permissions, and implementing authentication mechanisms across the cloud platform 400. System configuration tools may enable administrators to define and modify global settings and system policies that govern the operation of the entire cloud environment. Additionally, the management services 406 may offer monitoring and reporting functionalities to track resource utilization, system performance, and compliance with system policies.

The service identifier manager 408 may assign and manage unique identifiers for each service within the cloud platform 400, specifically, the main services providing cloud functionality (e.g., the infrastructure services 402, the shared services 404, and the management services 406). This component may collect and organize information about service dependencies, characteristics, and relationships of the main services. For example, the infrastructure services 402 may interact with the service identifier manager 408 to provide information about the underlying hardware and virtualization infrastructure supporting the cloud services; the shared services 404 may interact with the service identifier manager 408 to provide data about user interactions and system-wide events; and the management services 406 may interact with the service identifier manager 408 to provide information about administrative actions and system configurations. The service identifier manager 408 assigns a unique service identifier to each microservice it tracks. In some implementations, the service identifiers are identifiers within a DevOps platform. The service identifier manager 408 maintains data about the identified services, including their dependencies (both ancestor and dependent relationships), instance availability metrics, error budget allocations, redundancy configurations, and the like. As subsequently described, the service identifier manager 408 may provide this service information to the dependency mapping service 416, which uses the information to calculate availability estimates based on design constraints and service dependencies.

A management service 410 may oversee the operation and coordination of various components within the architecture. This service may handle tasks such as resource allocation, service deployment, and configuration management. The infrastructure services 402 may communicate with the management service 410 to provide data about user interactions and system-wide events. In some implementations, the management service 410 may be part of a third-party IT operations management platform, such as OpsRamp, which provides monitoring, alerting, and incident management capabilities across hybrid infrastructure environments.

A log analytics service 412 may collect and analyze log data from various components of the cloud platform 400. This service may process log entries to extract meaningful insights about service behavior, error patterns, and potential issues. The infrastructure services 402 may communicate with the log analytics service 412 to provide information about the underlying hardware and virtualization infrastructure. The log analytics service may collect runtime metrics from the services. In some aspects, the log analytics service 412 may work alongside other monitoring tools to provide monitoring capabilities for the cloud platform 400. In some implementations, the log analytics service 412 may be part of third-party tools such as Logz.io.

A metrics service 414 may gather quantitative performance data from the various services and components within the cloud platform 400. This may include metrics such as response times, error rates, resource utilization, throughput, latency, and system health indicators. The shared services 404 may communicate with the metrics service 414 to provide information about user interactions and system-wide events. The management services 406 may communicate with the metrics service 414 to provide information about administrative actions and system configurations. The metrics service 414 may collect time-series data, and may support data aggregation, real-time monitoring, and alerting based on predefined thresholds. In some implementations, the metrics service 414 may use a pull-based model to scrape metrics from instrumented targets at regular intervals, while in others, it may receive metrics pushed from the monitored services. The service may support service discovery mechanisms to automatically detect and monitor new instances or services as they are added to the cloud platform 400. In some implementations, the metrics service 414 may be part of an observability platform.

The dependency mapping service 416 may create and maintain a map of service dependencies within the cloud platform 400. This service may collect dependency information from the service identifier manager 408 and store it in the data store 422. The dependency information may include service characteristics of the dependent services, such as relationships between services, reliability parameters of the services, availability parameters of the services, and the like. The reliability parameters may include mean time between failure and/or mean time to repair of the services, while the availability parameters may include redundancy levels of the services. By maintaining this detailed dependency information, the dependency mapping service 416 enables more accurate analysis of service availability and potential points of failure.

The performance monitoring service 418 may analyze the metrics collected by the monitoring services (e.g., the management service 410, the log analytics service 412, and the metrics service 414) to provide insights into the overall health and performance of the service environment. This component may track key performance indicators, identify trends, and detect anomalies in service behavior across all entities with service identifiers (defined by the service identifier manager 408). The performance monitoring service 418 may generate a holistic view of operational metrics. These metrics may include response times, error rates, resource utilization, and transaction volumes, enabling the system to assess actual service availability. The performance monitoring service 418 may collect time-series data sets, supporting real-time monitoring, data aggregation, and alerting based on predefined thresholds.

The data store 422 may serve as a central repository for storing various types of data collected throughout the cloud platform 400. This may include the dependency information from the dependency mapping service 416, as well as service operation data from the monitoring services (e.g., the management service 410, the log analytics service 412, and the metrics service 414). The data store 422 may organize this information in a structured manner, potentially using time-series databases for metrics and graph databases for dependency relationships.

The drift detection service 420 may identify and analyze availability drift within the cloud platform 400. This service may retrieve data from the data store 422, including both the dependency information and operational metrics of the services with service identifiers. The drift detection service 420 may implement one or more algorithm(s) for drift identification. This process may involve calculating an estimated availability for a service based on the dependency information and service characteristics stored in the data store 422. The drift detection service 420 may also calculate actual availability of the service from operational metrics stored in the data store 422. It may then compare the estimated and actual availability. By analyzing the difference between these availability values over time, the drift detection service 420 may identify various types of drift for a service, such as sudden, gradual, incremental, or recurring drift patterns. The drift detection service 420 may also generate a drift heat map to visualize drift across services, providing a visual representation of problematic areas within the service environment.

The drift detection service 420 may implement a suitable algorithm to calculate estimated availability for services within the cloud platform 400. This algorithm may involve several steps to calculate the estimated availability based on various factors. First, the drift detection service 420 may determine individual estimated availability for each service based on a defined error budget. It may then consider service dependencies, analyzing how the availability of dependent services impacts the overall estimated availability of a core service. The algorithm may also take into account service redundancies, adjusting the estimated availability based on the number of replicas or redundant instances configured for each service. By combining these factors, the drift detection service 420 may generate a comprehensive estimate of service availability that reflects both the individual service characteristics and the interdependencies within the cloud platform 400. This process may involve recursive calculations to account for multi-level dependencies, so that the availability estimate for a core service considers the entire chain of dependent services and their respective configurations.

For example, when estimating the availability of a core service, the drift detection service 420 may consider a scenario where the core service depends on several dependent services. Each of these dependent services may have its own estimated availability based on individual error budgets and redundancy configurations. The algorithm may start by calculating the availability of the lowest-level dependencies, then work its way up the dependency chain. For example, if a first dependent service has an estimated availability of 99.9%, a second dependent service has an estimated availability of 99.95%, and a third dependent service has an estimated availability of 99.8%, the drift detection service 420 may combine these values using a multiplicative approach to determine the overall estimated availability of the core service. This calculation may also factor in the core service’s own characteristics, such as its redundancy level and error budget. The resulting estimated availability for the core service may be lower than any individual dependent service’s estimated availability, reflecting the cumulative impact of dependencies on the core service reliability. This approach, considering the core service’s dependencies, may enable more accurate prediction of potential service disruptions and inform proactive measures to maintain high availability.

The drift detection service 420 may also implement a suitable algorithm to calculate actual availability for services within the cloud platform 400. This algorithm may utilize the operational metrics collected by the monitoring services, such as response times, error rates, and transaction volumes of the tracked services. From these collected metrics, the algorithm may derive reliability measurements such as Mean Time Between Failures (MTBF) and Mean Time To Repair (MTTR) of the services. In some aspects, the algorithm may calculate the actual availability based on the service uptime and downtime. The MTBF may be calculated by dividing the total service time by the number of failures, while the MTTR may represent the average time taken to repair a service after a failure occurs. Using these derived metrics, the algorithm may compute the actual availability as a percentage by dividing the MTBF by the sum of MTBF and MTTR. This approach may provide a comprehensive and accurate representation of the service’s actual availability within the cloud platform 400.

When calculating the actual availability of a core service, the drift detection service 420 may analyze operational metrics of the core service collected over a specific time period. For example, actual availability may be calculated with a 60-minute Service Level Objective (SLO) window. During this window, the service may experience failures, each requiring time to repair. The drift detection service 420 may use these metrics to calculate the Mean Time Between Failures (MTBF) and Mean Time To Repair (MTTR) of the service. By considering these reliability measurements, the drift detection service 420 can determine the actual availability percentage of the service during the observed period.

The drift detection service 420 may implement suitable algorithms to identify drift by comparing estimated and actual availability of the services. This comparison process may involve analyzing time-series data collected from both the estimated availability calculations and the actual operational metrics. In some aspects, the drift detection service 420 may categorize different types of drift of a service based on specific patterns observed in the data.

The drift detection service 420 may detect sudden drift of a service, which may be characterized by an abrupt and significant change in its actual availability compared to its estimated availability. This type of drift may occur due to recent updates, configuration changes, or unexpected failures in the service or its dependencies.

The drift detection service 420 may detect gradual drift of a service, which may be characterized by a slow but consistent divergence between its estimated and actual availability over time. This type of drift may occur due to performance degradation or scalability issues that become more pronounced as the service or its dependencies operate under increasing load.

The drift detection service 420 may detect incremental drift of a service, which may be characterized by step-wise changes in availability that correspond to specific events or modifications in the service environment. This type of drift may occur due to architectural changes or updates to the service or its dependencies that have cascading effects on overall availability.

The drift detection service 420 may detect recurring drift of a service, which may be characterized by cyclical fluctuations in actual availability. This type of drift may occur due to usage patterns, scheduled maintenance activities, or periodic resource constraints.

To perform drift detection analysis, the drift detection service 420 may employ various statistical and mathematical techniques. It may use moving averages, trend analysis, or time-series analysis methods such as Fourier transforms to decompose the availability data for a service into its constituent components. This decomposition may allow for the isolation of different drift types and facilitate more accurate root cause analysis. In some implementations, the drift detection service 420 may utilize machine learning algorithms to improve drift detection capabilities over time. These algorithms may learn from historical drift patterns and their associated root causes to enhance the accuracy and speed of future drift identification. The drift detection service 420 may also incorporate threshold-based alerting mechanisms. It may allow for the configuration of different sensitivity levels for various drift types, enabling more granular control over when and how drift notifications are triggered.

The user interface 424 may provide a visual representation of the data and analysis produced by the various components of the cloud platform 400. This interface may display the dependency map generated by the dependency mapping service 416, the performance metrics from the performance monitoring service 418, and the drift heat map from the drift detection service 420. The user interface 424 may allow administrators to interact with the data, drill down into specific services or time periods, and initiate actions based on the insights provided.

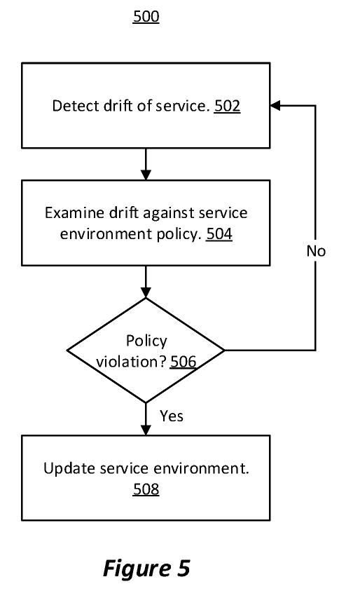

FIG. 5 illustrates a flowchart of a method 500 for detecting and responding to service drift, according to some implementations. The method 500 will be described in conjunction with the service environment 300 of FIG. 3. The method 500 may be performed to monitor and manage service availability within the service environment 300. For example, at least some steps may be performed by the reliability server 308 (e.g., the reliability service 318 running thereon).

In step 502, the reliability server 308 detects drift of a service. This detection may involve comparing the estimated availability of the core service 314 (calculated based on dependency information) with the actual availability of the core service 314 (calculated based on operational metrics). The reliability server 308 may analyze time-series data to identify various types of drift patterns, such as sudden, gradual, incremental, or recurring drift of the core service 314.

In step 504, the reliability server 308 examines the detected drift against a policy of the service environment 300. This examination may involve analyzing the magnitude and trajectory of the drift to determine if it will exceed policy thresholds within a certain time frame. The policy may define acceptable levels of service availability and performance within the service environment 300.

In step 506, the reliability server 308 determines whether there is or will be a policy violation. This determination may involve predicting whether the current drift pattern of the core service 314 will cause its actual availability to fall below a threshold specified in the policy. The reliability server 308 may use statistical analysis and forecasting techniques to make this prediction based on the observed drift and historical service data.

In step 508, the service environment 300 is updated in response to detection of a policy violation. The specific update(s) performed may depend on the root cause of the drift, which the reliability server 308 may determine through analysis of the dependency information and operational metrics. Examples of the updates may include adjusting resource allocations to the core service 314 and/or the dependent service 316, modifying service configurations, or implementing other changes to improve service reliability. The update to the service environment 300 may be performed automatically (by, e.g., the reliability server 308) or manually (by, e.g., a system administrator).

The reliability server 308 may calculate a deadline for updating the service environment 300 based on the dependency information and the rate of drift. This deadline may represent the point at which the drift is predicted to cause a policy violation if left unaddressed. The reliability server 308 may prioritize updates to the service environment 300 based on these calculated deadlines so that more important issues are addressed first.

In some cases, the reliability server 308 may perform updates to the service environment 300 automatically, without administrator intervention. Updating the service environment 300 may include the automatic execution of runbooks to remediate drift issues. The runbooks may include predefined sets of actions to address specific types of drift or service issues. In some implementations, the reliability server 308 may increase computing resource allocation to impacted services 314 or 316, adjust redundancy levels of impacted services 314 or 316, modify load balancing configurations, or the like. In some implementations, the reliability server 308 may integrate with DevOps tools to facilitate the update process. For example, the reliability server 308 may interface with continuous integration and deployment systems to automate the rollback of problematic changes (to impacted services 314 or 316) that may be causing drift. Similarly, the reliability server 308 may automatically generate code patches to address identified issues in the impacted services 314 or 316, submit these code patches to version control systems, trigger automated build processes to compile the updated code, and deploy the updated service to the appropriate environment. This integration may allow for rapid responses to detected issues, reducing impacts on service availability.

In some cases, the updates to the service environment 300 may be performed by an administrator. The reliability server 308 may notify the administrator of the drift, root cause, and/or deadline, thereby providing sufficient time for the administrator to implement the necessary changes before a policy violation occurs. Specifically, the reliability server 308 may generate alerts including the root cause of the drift and the deadline for updating the service environment 300. These alerts may be sent to system administrators or other relevant personnel, providing them with actionable information to address the drift manually if automated updates are not performed.

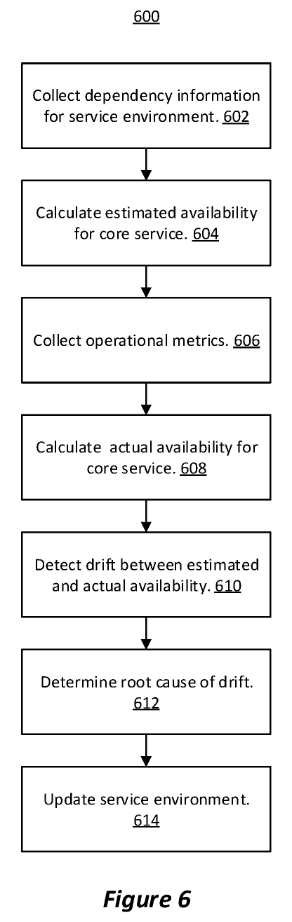

FIG. 6 illustrates a flowchart of a method 600 for monitoring and managing service availability, according to some implementations. The method 600 will be described in conjunction with the service environment 300 of FIG. 3. The method 600 may be performed to monitor and manage service availability within the service environment 300. For example, at least some steps may be performed by the reliability server 308 (e.g., the reliability service 318 running thereon).

In step 602, the reliability server 308 collects dependency information for a service environment 300. The service environment 300 may include a core service 314 and dependent services 316, where the core service 314 depends on the dependent services 316. In some cases, the dependency information may indicate relationships between the dependent services 316 and the core service 314. The dependency information may include service characteristics of the dependent services 316. The service characteristics of the dependent services 316 may include reliability parameters and availability parameters of the dependent services 316, where the reliability parameters include mean times between failure of the dependent services 316, and the availability parameters include redundancy levels of the dependent services 316. The reliability server 308 may collect this information from various sources, including a service identifier manager or directly from the services themselves.

In step 604, the reliability server 308 calculates an estimated availability for the core service 314 based on the service characteristics of the dependent services 316. In some implementations, the estimated availability for the core service 314 may be further calculated based on the relationships between the dependent services 316 and the core service 314. The reliability server 308 may use various algorithms to perform this calculation, taking into account factors such as the reliability parameters and availability parameters of the dependent services 316.

In step 606, the reliability server 308 collects operational metrics for the core service 314 and the dependent services 316. These operational metrics may include data such as response times, error rates, and resource utilization. The reliability server 308 may collect these metrics through monitoring hosts/services or directly from the services 314 and 316 themselves.

In step 608, the reliability server 308 calculates an actual availability for the core service 314 based on the collected operational metrics. This calculation may involve analyzing the performance data of the core service 314 over a specific time period to determine its actual uptime and reliability.

In step 610, the reliability server 308 detects a drift between the estimated availability and the actual availability for the core service 314. This may involve comparing the calculated estimated availability from step 604 with the calculated actual availability from step 608. The reliability server 308 may use various statistical techniques to identify and quantify discrepancies between these two values.

In step 612, the reliability server 308 determines a root cause of the drift by analyzing the dependency information. This analysis may involve examining how changes or issues in the dependent services 316 may be impacting the core service 314. In some implementations, determining the root cause of the drift may include identifying an impacted service of the dependent services 316. The reliability server 308 may also identify a type of the drift by analyzing time-series data for the estimated availability and time-series data for the actual availability. The root cause of the drift may be determined based on the type of the drift identified.

In step 614, the service environment 300 is updated based on the root cause of the drift. The specific updates may vary depending on the identified root cause. In some cases, updating the service environment 300 may include increasing a computing resource allocation to the impacted service in the service environment 300. In other cases, updating the service environment 300 may include increasing a redundancy level of the impacted service in the service environment 300. These updates may be performed automatically by the reliability server 308 or may be implemented manually by system administrators based on recommendations from the reliability server 308.

As part of updating, the reliability server 308 may examine the drift against a policy of the service environment 300 and predict whether the policy will be violated by the drift. The updating of the service environment 300 may be performed automatically in response to predicting the policy will be violated. Additionally or alternatively, in response to predicting the policy will be violated, the reliability server 308 may calculate a deadline for updating the service environment 300 based on the dependency information and generate an alert including the root cause of the drift and the deadline for updating the service environment 300.

The disclosed system and methods provide a comprehensive approach for monitoring and managing service availability in a dependency-aware manner. By collecting and analyzing dependency information, calculating estimated and actual availability, and detecting drift between these values, the system can proactively identify potential issues before they lead to service disruptions or system policy violations. The ability to determine root causes of drift and automatically update the service environment or alert administrators allows for rapid response and mitigation of availability problems. This approach may improve overall service reliability, reduce downtime, and help maintain compliance with system policies.

In an example implementation, a system includes: service hosts running a service environment including a core service and dependent services, the core service depending on the dependent services; and a reliability server configured to: collect dependency information for the service environment, the dependency information including service characteristics of the dependent services; calculate an estimated availability for the core service based on the service characteristics of the dependent services; collect operational metrics for the core service and the dependent services; calculate an actual availability for the core service based on the operational metrics; detect a drift between the estimated availability and the actual availability for the core service; determine a root cause of the drift by analyzing the dependency information; and update the service environment based on the root cause of the drift. In some implementations of the system, to determine the root cause of the drift, the reliability server is further configured to identify an impacted service of the dependent services, and where, to update the service environment, the reliability server is further configured to increase a computing resource allocation to the impacted service in the service environment. In some implementations of the system, to determine the root cause of the drift, the reliability server is further configured to identify an impacted service of the dependent services, and where, to update the service environment, the reliability server is further configured to increase a redundancy level of the impacted service in the service environment. In some implementations of the system, the dependency information indicates relationships between the dependent services and the core service, and the reliability server is further configured to calculate the estimated availability for the core service based on the relationships. In some implementations of the system, to determine the root cause of the drift, the reliability server is further configured to identify a type of the drift by analyzing time-series data for the estimated availability and time-series data for the actual availability, the root cause of the drift being determined based on the type of the drift. In some implementations of the system, the service characteristics of the dependent services include reliability parameters and availability parameters of the dependent services, the reliability parameters including mean times between failure of the dependent services, the availability parameters including redundancy levels of the dependent services. In some implementations of the system, the reliability server is further configured to: examine the drift against a policy of the service environment; and predict whether the policy will be violated by the drift, where the service environment is automatically updated in response to predicting the policy will be violated.

In an example implementation, a device includes: a processor; and a non-transitory computer-readable medium storing instructions which, when executed by the processor, cause the processor to: collect dependency information for a service environment, the service environment including a core service and dependent services, the core service depending on the dependent services, the dependency information including service characteristics of the dependent services; collect operational metrics for the core service and the dependent services; detect a drift between an estimated availability and an actual availability for the core service based on the service characteristics and the operational metrics; determine a root cause of the drift by analyzing the dependency information; and update the service environment based on the root cause of the drift. In some implementations of the device, the instructions to determine the root cause of the drift include instructions to identify an impacted service of the dependent services, and the instructions to update the service environment include instructions to increase a computing resource allocation to the impacted service in the service environment. In some implementations of the device, the instructions to determine the root cause of the drift include instructions to identify an impacted service of the dependent services, and the instructions to update the service environment include instructions to increase a redundancy level of the impacted service in the service environment. In some implementations of the device, the dependency information indicates relationships between the dependent services and the core service. In some implementations of the device, the service characteristics of the dependent services include reliability parameters and availability parameters of the dependent services, the reliability parameters including mean times between failure of the dependent services, the availability parameters including redundancy levels of the dependent services.

In an example implementation, a method includes: collecting, by a reliability server, dependency information for a service environment, the service environment including a core service and dependent services, the core service depending on the dependent services, the dependency information including service characteristics of the dependent services; calculating, by the reliability server, an estimated availability for the core service based on the service characteristics of the dependent services; collecting, by the reliability server, operational metrics for the core service and the dependent services; calculating, by the reliability server, an actual availability for the core service based on the operational metrics; detecting, by the reliability server, a drift between the estimated availability and the actual availability for the core service; determining, by the reliability server, a root cause of the drift by analyzing the dependency information; and updating the service environment based on the root cause of the drift. In some implementations of the method, determining the root cause of the drift includes identifying an impacted service of the dependent services, and updating the service environment includes increasing a computing resource allocation to the impacted service in the service environment. In some implementations of the method, determining the root cause of the drift includes identifying an impacted service of the dependent services, and updating the service environment includes increasing a redundancy level of the impacted service in the service environment. In some implementations of the method, the dependency information indicates relationships between the dependent services and the core service, and the estimated availability for the core service is further calculated based on the relationships. In some implementations of the method, determining the root cause of the drift includes identifying a type of the drift by analyzing time-series data for the estimated availability and time-series data for the actual availability, the root cause of the drift being determined based on the type of the drift. In some implementations of the method, the service characteristics of the dependent services include reliability parameters and availability parameters of the dependent services, the reliability parameters including mean times between failure of the dependent services, the availability parameters including redundancy levels of the dependent services. In some implementations, the method further includes: examining, by the reliability server, the drift against a policy of the service environment; and predicting, by the reliability server, whether the policy will be violated by the drift, where the updating the service environment is performed automatically in response to predicting the policy will be violated. In some implementations, the method further includes: examining, by the reliability server, the drift against a policy of the service environment; predicting, by the reliability server, whether the policy will be violated by the drift; in response to predicting the policy will be violated: calculating, by the reliability server, a deadline for updating the service environment based on the dependency information; and generating, by the reliability server, an alert including the root cause of the drift and the deadline for updating the service environment.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A system comprising:
service hosts running a service environment comprising a core service and dependent services, the core service depending on the dependent services; and
a reliability server configured to:
collect dependency information for the service environment, the dependency information comprising service characteristics of the dependent services;
calculate an estimated availability for the core service based on the service characteristics of the dependent services;
collect operational metrics for the core service and the dependent services;
calculate an actual availability for the core service based on the operational metrics;
detect a drift between the estimated availability and the actual availability for the core service;
determine a root cause of the drift by analyzing the dependency information; and
update the service environment based on the root cause of the drift.

2. The system of claim 1, wherein, to determine the root cause of the drift, the reliability server is further configured to identify an impacted service of the dependent services, and wherein, to update the service environment, the reliability server is further configured to increase a computing resource allocation to the impacted service in the service environment.

3. The system of claim 1, wherein, to determine the root cause of the drift, the reliability server is further configured to identify an impacted service of the dependent services, and wherein, to update the service environment, the reliability server is further configured to increase a redundancy level of the impacted service in the service environment.

4. The system of claim 1, wherein the dependency information indicates relationships between the dependent services and the core service, and the reliability server is further configured to calculate the estimated availability for the core service based on the relationships.

5. The system of claim 1, wherein, to determine the root cause of the drift, the reliability server is further configured to identify a type of the drift by analyzing time-series data for the estimated availability and time-series data for the actual availability, the root cause of the drift being determined based on the type of the drift.

6. The system of claim 1, wherein the service characteristics of the dependent services comprise reliability parameters and availability parameters of the dependent services, the reliability parameters comprising mean times between failure of the dependent services, the availability parameters comprising redundancy levels of the dependent services.

7. The system of claim 1, wherein the reliability server is further configured to:
examine the drift against a policy of the service environment; and
predict whether the policy will be violated by the drift, wherein the service environment is automatically updated in response to predicting the policy will be violated.

8. A device comprising:
a processor; and
a non-transitory computer-readable medium storing instructions which, when executed by the processor, cause the processor to:
collect dependency information for a service environment, the service environment comprising a core service and dependent services, the core service depending on the dependent services, the dependency information comprising service characteristics of the dependent services;
collect operational metrics for the core service and the dependent services;
detect a drift between an estimated availability and an actual availability for the core service based on the service characteristics and the operational metrics;
determine a root cause of the drift by analyzing the dependency information; and
update the service environment based on the root cause of the drift.

9. The device of claim 8, wherein the instructions to determine the root cause of the drift comprise instructions to identify an impacted service of the dependent services, and the instructions to update the service environment comprise instructions to increase a computing resource allocation to the impacted service in the service environment.

10. The device of claim 8, wherein the instructions to determine the root cause of the drift comprise instructions to identify an impacted service of the dependent services, and the instructions to update the service environment comprise instructions to increase a redundancy level of the impacted service in the service environment.

11. The device of claim 8, wherein the dependency information indicates relationships between the dependent services and the core service.

12. The device of claim 8, wherein the service characteristics of the dependent services comprise reliability parameters and availability parameters of the dependent services, the reliability parameters comprising mean times between failure of the dependent services, the availability parameters comprising redundancy levels of the dependent services.

13. A method comprising:
collecting, by a reliability server, dependency information for a service environment, the service environment comprising a core service and dependent services, the core service depending on the dependent services, the dependency information comprising service characteristics of the dependent services;
calculating, by the reliability server, an estimated availability for the core service based on the service characteristics of the dependent services;
collecting, by the reliability server, operational metrics for the core service and the dependent services;
calculating, by the reliability server, an actual availability for the core service based on the operational metrics;
detecting, by the reliability server, a drift between the estimated availability and the actual availability for the core service;
determining, by the reliability server, a root cause of the drift by analyzing the dependency information; and
updating the service environment based on the root cause of the drift.

14. The method of claim 13, wherein determining the root cause of the drift comprises identifying an impacted service of the dependent services, and updating the service environment comprises increasing a computing resource allocation to the impacted service in the service environment.

15. The method of claim 13, wherein determining the root cause of the drift comprises identifying an impacted service of the dependent services, and updating the service environment comprises increasing a redundancy level of the impacted service in the service environment.

16. The method of claim 13, wherein the dependency information indicates relationships between the dependent services and the core service, and the estimated availability for the core service is further calculated based on the relationships.

17. The method of claim 13, wherein determining the root cause of the drift comprises identifying a type of the drift by analyzing time-series data for the estimated availability and time-series data for the actual availability, the root cause of the drift being determined based on the type of the drift.

18. The method of claim 13, wherein the service characteristics of the dependent services comprise reliability parameters and availability parameters of the dependent services, the reliability parameters comprising mean times between failure of the dependent services, the availability parameters comprising redundancy levels of the dependent services.

19. The method of claim 13, further comprising:
examining, by the reliability server, the drift against a policy of the service environment; and
predicting, by the reliability server, whether the policy will be violated by the drift, wherein the updating the service environment is performed automatically in response to predicting the policy will be violated.

20. The method of claim 13, further comprising:
examining, by the reliability server, the drift against a policy of the service environment;
predicting, by the reliability server, whether the policy will be violated by the drift;
in response to predicting the policy will be violated:
calculating, by the reliability server, a deadline for updating the service environment based on the dependency information; and
generating, by the reliability server, an alert comprising the root cause of the drift and the deadline for updating the service environment.
